(19) United States
(12) Patent Application Publication
(10) Pub. No.: US 2017/0174306 A1
(43) Pub. Date: Jun. 22, 2017

(54) METHOD FOR OPERATING ENGINE FOR VESSEL

(71) Applicant: DAEWOO SHIPBUILDING & MARINE ENGINEERING CO., LTD., Seoul (KR)

(72) Inventors: Byung Tak NAM, Geoje-si (KR); Kyung Jin KWON, Geoje-si (KR)

(73) Assignee: DAEWOO SHIPBUILDING & MARINE ENGINEERING CO., LTD., Seoul (KR)

(21) Appl. No.: 15/327,003

(22) PCT Filed: Apr. 3, 2015
(86) PCT No.: PCT/KR2015/003369

§ 371 Date: Jan. 17, 2017

(30) Foreign Application Priority Data
Jul. 18, 2014 (KR) 10-2014-0090945
Jul. 23, 2014 (KR) 10-2014-0093223
Sep. 29, 2014 (KR) 10-2014-0130209
Sep. 29, 2014 (KR) 10-2014-0130210
Feb. 9, 2015 (KR) 10-2015-0019185

(51) Int. Cl. B63H 21/38; F02B 75/02; F02D 19/08; F02D 19/02; F02D 19/06; B63H 21/21; F02M 21/02

(52) U.S. Cl. CPC B63H 21/38; B63H 21/21; F02B 75/02; F02M 21/0215; F02M 21/0221; F02D 19/02; F02D 19/0613; F02D 19/0628; F02D 19/0647; F02D 19/08; B63B 2758/00

(57) ABSTRACT

Disclosed is a method for operating an engine for a vessel including an engine which can use both natural gas and fuel oil as fuel. According to the method for operating an engine for a vessel, each engine is operated in one of modes including: a gas mode in which the engine is driven using natural gas as fuel; a fuel oil mode in which the engine is driven using fuel oil as fuel; and a fuel distribution mode in which the engine simultaneously uses natural gas and fuel oil as fuel.

### TECHNICAL FIELD

The present invention relates to an engine operating method for a ship including an engine fueled by natural gas and fuel oil at the same time.

### BACKGROUND ART

Generally, natural gas is liquefied and transported over a long distance in the form of liquefied natural gas (LNG). Liquefied natural gas is obtained by cooling natural gas to a very low temperature of about −163° C. at an atmospheric pressure and is well suited to long-distance transportation by sea because the volume thereof is significantly reduced, as compared with natural gas in a gaseous state.

Even when a liquefied natural gas storage tank is insulated, there is a limit to completely blocking external heat. Thus, liquefied natural gas is continuously vaporized in the liquefied natural gas storage tank by heat transferred into the storage tank. Liquefied natural gas vaporized in the storage tank is referred to as boil-off gas (BOG).

If the pressure in the storage tank exceeds a predetermined safe pressure due to generation of boil-off gas, the boil-off gas is discharged from the storage tank through a safety valve. The boil-off gas discharged from the storage tank is used as fuel for a ship, or is re-liquefied and returned to the storage tank.

### DISCLOSURE

### Technical Problem

It is an aspect of the present invention to provide an efficient engine operating method for a ship including engines fueled by natural gas and fuel oil at the same time.

### Technical Solution

In accordance with one aspect of the present invention, there is provided an engine operating method for a ship including engines operable using natural gas and fuel oil at the same time, wherein each of the engines is operated in any one of a gas mode in which each of the engines is driven using natural gas as a fuel, a fuel oil mode in which each of the engines is driven using fuel oil as a fuel, and a fuel sharing mode in which each of the engines is driven using natural gas and fuel oil at the same time.

Each of the engines may be operated in the fuel sharing mode through a process including: switching the engine to the fuel sharing mode; determining proportion of gas burned in the fuel sharing mode; calculating amount of gas consumed in the fuel sharing mode; and providing feedback on the state of the engine in the fuel sharing mode.

The engine operating method may be determined by a power management system and a gas management system of an integrated automation system operated in conjunction with each other and the power management system may be operated in any one of a diesel mode in which a plurality of engines of the ship are all in the fuel oil mode, a first mixed mode in which some of the plurality of engines are in the fuel oil mode and some of other engines are in the gas mode, a gas only mode in which the plurality of engines are all in the gas mode, a fuel sharing only mode in which the plurality of engines are all in the fuel sharing mode, a second mixed mode in which some of the plurality of engines are in the fuel sharing mode and some of other engines are in the gas mode, and a third mixed mode in which some of the plurality of engines are in the fuel sharing mode and some of the other engines are in the fuel oil mode.

The gas management system may measure an internal pressure of a liquefied natural gas storage tank provided to the ship and calculate a total load assignable to engines in the gas mode or proportion of a gas-based load among the total load assignable to engines in the fuel sharing mode based on the measured internal pressure of the storage tank.

The gas management system may forcibly switch an engine operating in the gas mode to the fuel oil mode or the fuel sharing mode if the internal pressure of the storage tank decreases, and may send surplus boil-off gas to a gas combustion unit for combustion or vent surplus boil-off gas if the internal pressure of the storage tank increases.

The integrated automation system may automatically assign a load to each engine based on information on the total loads assignable to engines in the gas mode and engines in the fuel sharing mode calculated by the gas management system based on the internal pressure of the storage tank.

The power management system may be operated in the fuel sharing only mode, wherein the gas management system (a) determines an amount of boil-off gas expected to be used as a fuel based on the measured pressure of boil-off gas in the storage tank and calculates the maximum load obtainable when operating the engines in the fuel sharing mode using a determined amount of boil-off gas (hereinafter, “maximum boil-off gas-based engine load”); (b) calculates a “boil-off gas-based load assigned to each engine” by dividing the “maximum boil-off-based engine load”, calculated in (a), by the “total number of engines”; (c) determines a ratio of natural gas to fuel oil for each engine based on the “boil-off gas-based load assigned to each engine” calculated in (b); (d) operates each engine such that fuel oil and boil-off gas in the storage tank are used as a fuel according to the ratio determined in (c); and (e) repeats the procedure from (a) to (d) based on a changed pressure if the pressure of boil-off gas in the storage tank is changed during operation of each engine.

The power management system may be operated in the second mixed mode, wherein the gas management system (a) determines an amount of boil-off gas expected to be used as a fuel based on the measured pressure of boil-off gas in the storage tank and calculates the maximum load obtainable when operating the engines in the fuel sharing mode and the engines in the gas mode using a determined amount of boil-off gas (hereinafter, “maximum boil-off gas-based engine load”); (b) distributes the “maximum boil-off gas-based engine load” calculated in (a) to the engines in the gas mode; (c) calculates a “boil-off gas-based load assigned to each of the engines in the fuel sharing mode” by dividing the “maximum boil-off gas-based engine load” excluding the load distributed to the engines in the gas mode in (b) by the “number of engines in the fuel sharing mode”; (d) determines a ratio of natural gas to fuel oil for each of the engines in the fuel sharing mode based on the “boil-off gas-based load assigned to each of the engines in the fuel sharing mode” calculated in (c); (e) operates each engine such that fuel oil and boil-off gas in the storage tank are used as a fuel according to the load met by the engines in the gas mode, determined in (b), and the ratio of natural gas to fuel oil for each of the engines in the fuel sharing mode, determined in (d); (f) repeats the procedure from (a) to (e) based on a changed pressure if the pressure of boil-off gas in the storage tank is changed during operation of each engine; (g) increases proportion of fuel oil for the engines in the fuel sharing mode if the amount of boil-off gas in the storage tank is reduced, and switches some or all of the engines in the gas mode to the fuel sharing mode if fuel oil is required above a certain level.

The power management system may be operated in the third mixed mode, wherein the gas management system (a) determines an amount of boil-off gas expected to be used as a fuel based on the measured pressure of boil-off gas in the storage tank and calculates the maximum load obtainable when operating the engines in the fuel sharing mode using a determined amount of boil-off gas (hereinafter, “maximum boil-off gas-based engine load”); (b) calculates a “boil-off gas-based load assigned to each of the engines in the fuel sharing mode” by dividing the “maximum boil-off gas-based engine load”, calculated in (a), by the “total number of engines in the fuel sharing mode”; (c) determines a ratio of natural gas to fuel oil for each of the engines in the fuel sharing mode based on the “boil-off gas-based load assigned to each of the engines in the fuel sharing mode” calculated in (b); (d) assigns engine output required for the ship, excluding the load assigned to the engines in the fuel sharing mode, to engines in the fuel oil mode; (e) operates each engine such that fuel oil and boil-off gas in the storage tank are used as a fuel according to the ratio of natural gas to fuel oil for each of the engines in the fuel sharing mode, determined in (c) and the load assigned to the engines in the fuel oil mode, determined in (d); and (f) repeats the procedure from (a) to (e) based on a changed pressure if the pressure of boil-off gas in the storage tank is changed during operation of each engine.

Each of the engines may be operated manually by a user operating the ship, wherein if boil-off gas in the storage tank is sufficient to drive the engine, the user personally determines a point at which optimum efficiency can be achieved within a range of amount of boil-off gas allowable by the power management system (PMS) and the gas management system (GMS), and if boil-off gas in the storage tank is not sufficient to drive the engine, the user personally determines a point at which optimum efficiency can be achieved to the extent that an operation method of forcibly vaporizing liquefied natural gas in the storage tank is maintained.

Each of the engines may be operated in the fuel sharing mode, wherein a load of the engine may be determined to be 15% or more and 85% or less of a total load of the engine.

Each of the engines may be operated in the fuel sharing mode, wherein proportion of a gas-based load among a load of the engine may be determined to be 15% or more and 85% or less of the load of the engine.

Each of the engines may be operated in the fuel sharing mode, wherein as a load of the engine increases, the maximum proportion of a gas-based load among the load of the engine may increase and the minimum proportion of a gas-based load among the load of the engine may decrease.

The power management system may be operated in the second mixed mode, wherein the number of engines in the gas mode may be maximized and the number of engines in the fuel sharing mode may be minimized.

The ship may include a plurality of engines, wherein a load of each individual engine may be maximized to minimize the number of engines to be driven.

The engine operating method may include: (a) calculating a “total gas-based engine load” based on a pressure of boil-off gas in the storage tank; (b) calculating a “total fuel oil-based engine load” by subtracting the “total gas-based engine load” calculated in (a) from engine output required for the ship; (c) determining the number of engines of the ship to be driven by taking into account the engine output required for the ship and the maximum output of each engine (hereinafter, “the number of running engines”); (d) determining a “gas-based engine load” assigned to each engine by dividing the “total gas-based engine load” calculated in (a) by the “number of running engines” calculated in (c); and (e) determining the number of engines that will share the “total fuel oil-based engine load” calculated in (b) by taking into account the maximum load of each engine.

The respective “gas-based engine loads” of engines in the gas mode and engines in the fuel sharing mode may be the same.

The respective loads of engines in the gas mode may be the same and the respective loads of engines in the fuel sharing mode may be the same.

Each of the engines may be a four-stroke DF engine for power generation.

In accordance with another aspect of the present invention, there is provided a ship including a plurality of DF engines operable in a fuel sharing mode, wherein the plurality of DF engines are operated in a gas mode or the fuel sharing mode and the number of DF engines operated in the gas mode is maximized and a load of each of the plurality of DF engines is maximized.

### Advantageous Effects

According to the engine operating method for a ship according to the present invention, among a plurality of engines operable in a gas mode or a fuel sharing mode, the number of engines operating in the gas mode is maximized, whereby it is possible to use gas that will be discarded when operating an engine in the fuel sharing mode, to minimize instability in the fuel sharing mode, and to minimize emission of nitrogen oxides and sulfur oxides generated during engine combustion.

Since an engine operated in the fuel sharing mode is fueled by both gas and fuel oil, the gas is burnt at a low load, causing high gas consumption. In contrast, an engine operated in the gas mode allows gas to be burnt at a high load. According to the engine operating method for a ship according to the present invention, among a plurality of engines operable in the gas mode or the fuel sharing mode, the number of engines operating in the gas mode is maximized, thereby reducing gas consumption.

In addition, according to the engine operating method for a ship according to the present invention, a load of each individual engine provided to the ship is maximized, thereby extending the service life of the engines.

### DESCRIPTION OF DRAWINGS

FIG. 1 is a graph showing the proportion of a gas-based load among a load of an engine in a fuel sharing mode (FSM) as a function of the engine load.

FIG. 2 is a graph showing a typical engine operating method for a ship when the total engine output required for the ship is 24,000 kW.

FIG. 3 is a graph showing an engine operating method for a ship according to one embodiment of the present invention when the total engine output required for the ship is 24,000 kW.

FIG. 4 is a graph showing a typical engine operating method for a ship when the total engine output required for the ship is 20,000 kW.

FIG. 5 is a graph showing an engine operating method for a ship according to one embodiment of the present invention when the total engine output required for the ship is 20,000 kW.

### EMBODIMENTS

Hereinafter, embodiments of the present invention will be described with reference to the accompanying drawings. A ship to which an engine operating method according to the present invention is applied may be a ship for various purposes, such as a liquefied natural gas carrier, a liquefied natural gas-fueled ship, a drillship, and an offshore structure. Although an engine to which the engine operating method for a ship according to the present invention is applied is preferably a DF engine, it should be understood that the present invention is not limited thereto and the engine operating method may be applied to any engine fueled by both fuel oil and natural gas. Herein, the case where the engine operating method for a ship according to the present invention is applied to a DF engine will be described by way of example. It should be understood that the present invention may be embodied in different ways and is not limited to the following embodiments.

Among engines used in a ship, an example of an engine that can be fueled by natural gas is a dual fuel (DF) engine. The DF engine is an engine that can be fueled by both natural gas and fuel oil and may be divided into a four-stroke power generation engine and a two-stroke main propulsion engine.

A four-stroke DF engine for power generation is commonly referred to as a DF engine and is connected to a generator, and the load of the engine depends on the connected generator. When devices connected to the generator require more power, torque rotating the generator is increased. As the torque is increased, the revolution per minute (RPM) of the generator is reduced and more fuel is injected into the engine by a governor of the engine to compensate for reduction in the RPM such that the RPM of the engine is increased, thereby maintaining the rotational speed of the engine at a constant level. Since the load of the engine depends on the rotational speed and torque of the engine, the load of the engine may be regulated by maintaining the rotational speed of the engine at a constant level and adjusting the torque.

TABLE 1

| Load | Gas | Fuel oil |
|---|---|---|
| % | (kJ/kWh) | (g/kWh) |
| 100 | 7300 | 189.0 |
| 95 | 7320 | 189.2 |
| 90 | 7345 | 189.5 |
| 85 | 7400 | 190.0 |
| 80 | 7500 | 191.0 |
| 75 | 7620 | 192.0 |
| 70 | 7700 | 193.4 |
| 65 | 7820 | 195.0 |
| 60 | 7950 | 197.5 |
| 55 | 8100 | 200.5 |
| 50 | 8260 | 204.0 |
| 45 | 8500 | 209.0 |
| 40 | 8800 | 215.0 |
| 35 | 9175 | 223.0 |
| 30 | 9560 | 231.0 |

Table 1 shows fuel consumption according to engine load when the four-stroke DF engine for power generation rotates at a constant speed. Referring to Table 1, it can be seen that as the engine load increases, fuel consumption linearly decreases. That is, as the engine is operated at a higher load, efficiency of the engine becomes better.

Examples of the two-stroke DF engine for main propulsion include an X-DF engine, an ME-GI engine, and the like, and the two-stroke DF engine for main propulsion is connected to a propeller, not a generator, since the engine is an engine for propelling a ship. Unlike the four-stroke DF engine, the fuel consumption of the two-stroke DF engine is high at a low load, is low at a medium load, and becomes high again at a high load, rather being linearly reduced as the engine load increases.

Although a typical DF engine can be fueled by both natural gas and fuel oil, the engine cannot use natural gas and fuel oil as a fuel at the same time. That is, a typical DF engine is driven either in a fuel oil (FO) mode or in a gas mode.

An engine operating method for a ship is mainly determined by how a power management system (PMS) and gas management system (GMS) of an integrated automation system (IAS) are linked together and operated. Methods of operating the power management system (PMS) and the gas management system (GMS) of a ship provided with a typical DF engine are as follows:

Since a typical DF engine can use either natural gas or fuel oil as a fuel, the power management system (PMS) of a ship provided with the typical DF engine is driven in any one of a diesel mode in which a plurality of engines of the ship are all in the fuel oil mode (FO mode), a mixed mode in which some of the plurality of engines are in the fuel oil mode (FO mode) and some of other engines are in the gas mode, and a gas only mode in which the plurality of engines are all in the gas mode.

The gas management system (GMS) of the ship provided with the typical DF engine measures an internal pressure of a storage tank and then calculates the total load assignable to the engines operated in the gas mode based on the measured internal pressure of the storage tank. The gas management system (GMS) of the ship provided with the typical DF engine forcibly switches an engine running in the gas mode to the fuel oil mode if the internal pressure of the storage tank decreases, and sends surplus boil-off gas to a gas combustion unit (GCU) for combustion or vents surplus boil-off gas to the outside if the internal pressure of the storage tank increases, while providing a user with information on the total load assignable to the engines operated in the gas mode, calculated based on the measured internal pressure of the storage tank. As such, the gas management system (GMS) of the ship provided with the typical DF engine may serve to maintain the internal pressure of the storage tank at a constant level.

The integrated automation system (IAS) of the ship provided with the DF engine may have a special function to automatically assign a load to each engine in the gas mode based on the information on the total load assignable to engines in the gas mode, calculated based on the internal pressure of the storage tank measured by the gas management system (GMS).

In the case where the integrated automation system (IAS) of the ship provided with the DF engine has a special function to automatically assign a load to each engine in the gas mode, when the pressure of boil-off gas in the storage tank is high, the engine load is increased and the speed of the ship increases, and when the pressure of boil-off gas in the storage tank is low, the engine load is decreased and the speed of the ship decreases.

One embodiment of a method in which an appropriate load of each engine is determined based on the pressure of boil-off gas in the storage tank by the gas management system (GMS) of the ship provided with the typical DF engine in a tank pressure control mode is as follows:

(a) The amount of boil-off gas expected to be used as a fuel is determined based on the measured pressure of boil-off gas in the storage tank, and the maximum load that can be obtained when operating engines in the gas mode using a determined amount of boil-off gas (hereinafter, “maximum boil-off gas-based engine load”) is calculated.

(b) The “maximum boil-off gas-based engine load” calculated in (a) is divided by the “number of engines in the gas mode” to calculate a “load assigned to each of the engines in the gas mode”.

(c) If engine output required for the ship is smaller than the “maximum boil-off gas-based engine load” calculated in (a), surplus boil-off gas is vented or burned in the gas combustion unit (GCU).

(d) If engine output required for the ship is greater than the “maximum boil-off gas-based engine load” calculated in (a), the engines in the gas-mode are operated such that the “load assigned to each of the engines in the gas-mode” calculated in (b) can be actually assigned to each of the engines in the gas mode, and the rest of the required engine output is allowed to be generated by engines in the fuel oil mode.

(e) If the engine output required for the ship cannot be met even when boil-off gas in the storage tank is entirely used and all of the engines in the fuel oil mode are used, liquefied natural gas in the storage tank is regasified and compressed to be used as a fuel.

A fuel gas supply system (FGGS) is used to regasify liquefied natural gas in the storage tank. The fuel gas supply system (FGGS) sends boil-off gas to engines if boil-off gas in the storage tank is sufficient to run the engines; sends surplus boil-off gas to the gas combustion unit (GCU) if boil-off gas in the storage tank is over-sufficient to run all the engines; and regasifies liquefied natural gas in the storage tank and sends the regasified liquefied natural gas to engines if boil-off gas in the storage tank is not sufficient to run the engines. The gas management system (GMS) controls the fuel gas supply system (FGGS) to maintain the internal pressure of the storage tank.

A fuel sharing mode (FSM) refers to a state in which a DF engine is fueled by natural gas and fuel oil at the same time. According to the present invention, a typical DF engine, which can only be operated either in the gas mode or in the fuel oil mode (FO mode), is improved not to have reduced combustion performance even when fuel oil and gas are injected into the engine at the same time so as to be operable in the fuel sharing mode as well as in the gas mode and the fuel oil mode (FO mode).

The DF engine, which is operated in any one of the gas mode, the fuel oil mode (FO mode), and the fuel sharing mode (FSM), may be operated in the fuel sharing mode (FSM) through a process including switching the engine to the fuel sharing mode (FSM), determining the proportion of gas burned in the fuel sharing mode (FSM), calculating the amount of gas consumed in the fuel sharing mode (FSM), and providing feedback on the state of the engine in the fuel sharing mode (FSM).

The DF engine operable in the fuel sharing mode (FSM) has the advantage that use of boil-off gas generated in the storage tank can be maximized, as compared with a typical DF engine.

Next, a case where a ship is provided with four DF engines each having a capacity of 10,000 kW, the total engine load required for the ship is 32,000 kW, boil-off gas generated in a storage tank is sufficient to produce a load of 30,000 kW, and the maximum load of each of the engines is 90% will be described by way of example.

When the DF engines are typical DF engines, in view of the fact that gas is less expensive than fuel oil, it is desirable that three engines be operated in the gas mode to each meet a load of 9,000 kW and one engine be operated in the fuel oil mode to meet the remaining 5,000 kW. However, in this case, there is a problem in that only the boil-off gas corresponding to 27,000 kW is used, and the boil-off gas corresponding to the remaining 3,000 kW is discarded.

When the DF engines are DF engines operable in the fuel sharing mode (FSM), in view of the fact that gas is less expensive than fuel oil, three engines are operated in the gas mode to each meet a load of 9,000 kW and one engine is operated in the fuel sharing mode to generate 3,000 kW using natural gas and generate 2,000 kW using fuel oil to meet the remaining 5,000 kW, thereby minimizing discarded boil-off gas.

In addition, the DF engine operable in the fuel sharing mode (FSM) has higher fuel oil combustion efficiency than a typical DF engine. That is, the DF engine operable in the fuel sharing mode (FSM) consumes less fuel oil to produce the same amount of load than a typical DF engine. Next, the case where a load of 300 kW is produced using fuel oil will be described by way of example.

Referring to Table 1, in a typical DF engine, when a DF engine having a capacity of 1,000 kW is operated in the fuel oil mode at a load of 30%, fuel oil is consumed in an amount of 231.0 g/kWh×300 kW=69,300.0 g/h.

Referring to Table 1, in the case of the DF engine operable in the fuel sharing mode (FSM), when a DF engine having a capacity of 1,000 kW is operated in the fuel sharing mode (FSM) at a load of 50% after the ratio of gas to fuel oil is set such that a load of 200 kW is produced using gas and a load of 300 kW is produced using fuel oil, the fuel oil is consumed in an amount of 204.0 g/kWh×300 kW=61,200.0 g/h.

It can be seen that the DF engine operable in the fuel sharing mode (FSM) has higher fuel oil combustion efficiency than a typical DF engine since the typical DF engine consumes 69,300.0 g/h of fuel oil and the DF engine operable in the fuel sharing mode (FSM) consumes 61,200.0 g/h of fuel oil to produce a load of 300 kW.

Next, methods of operating the power management system (PMS) and gas management system (GMS) of a ship provided with the DF engine which is operated in any one of the gas mode, the fuel oil (FO mode), and the fuel sharing mode (FSM) will be described.

Like the power management system (PMS) of a ship provided with a typical DF engine, the power management system (PMS) of a ship provided with the DF engine operable in the fuel sharing mode (FSM) may be driven in any one of the diesel mode, the mixed mode, and the gas only mode. Further, the power management system (PMS) of a ship provided with the DF engine operable in the fuel sharing mode (FSM) may also be operated in any one of a fuel sharing only mode in which a plurality of engines of the ship are all in the fuel sharing mode (FSM), a mixed mode in which some of the plurality of engines are in the fuel sharing mode (FSM) and some of other engines are in the fuel oil mode (FO mode), and a mixed mode in which some of the plurality of engines are in the fuel sharing mode (FSM) and some of other engines are in the gas mode.

The gas management system (GMS) of a ship provided with the DF engine operable in the fuel sharing mode (FSM) measures an internal pressure of a storage tank and then calculates the total load assignable to the engines operated in the gas mode and the proportion of a gas-based load among the total load assignable to the engines operated in the fuel sharing mode (FSM), based on the measured internal pressure of the storage tank.

In addition, the gas management system (GMS) of a ship provided with the DF engine operable in the fuel sharing mode (FSM) forcibly switches engines running in the gas mode to the fuel oil mode or the fuel sharing mode if the internal pressure of the storage tank decreases, and sends surplus boil-off gas to the gas combustion unit (GCU) for combustion or vents surplus boil-off gas to the outside if the internal pressure of the storage tank increases, while providing a user with information on the total load assignable to the engines operated in the gas mode and the proportion of a gas-based load among the total load assignable to the engines operated in the fuel sharing mode (FSM).

Like the gas management system (GMS) of a ship provided with a typical DF engine, the gas management system (GMS) of a ship provided with the DF engine operable in the fuel sharing mode (FSM) may serve to maintain the internal pressure of the storage tank at a constant level.

In the case where the integrated automation system (IAS) of a ship provided with the DF engine operable in the fuel sharing mode (FSM) has a special function to automatically assign a load to each engine based on the information on the total loads assignable to engines in the gas mode and engines in the fuel sharing mode, calculated by the gas management system (GMS) based on the internal pressure of the storage tank, when the pressure of boil-off gas in the storage tank is high, the load of the engines is increased and the speed of the ship increases, and when the pressure of boil-off gas in the storage tank is low, the load of the engines is decreased and the speed of the ship decreases, as in the case of the ship provided with a typical DF engine.

However, the gas management system (GMS) of a ship provided with the DF engine operable in the fuel sharing mode (FSM) may also be operated in the following manner since the gas management system is operated in conjunction with the power management system (PMS) which may be driven in any one of the fuel sharing only mode, the mixed mode of the fuel sharing mode (FSM) and the fuel oil mode (FO Mode), and the mixed mode of the fuel sharing mode (FSM) and the gas mode.

When the power management system (PMS) is in the fuel sharing only mode,

(a) the amount of boil-off gas expected to be used as a fuel is determined based on the measured pressure of boil-off gas in the storage tank, and the maximum load that can be obtained when operating the engines in the fuel sharing mode using a determined amount of boil-off gas (hereinafter, “maximum boil-off gas-based engine load”) is calculated.

(b) The “maximum boil-off gas-based engine load” calculated in (a) is divided by the “total number of engines” to calculate a “boil-off gas-based load assigned to each of the engines”.

(c) A ratio of natural gas to fuel oil for each engine is determined based on the “boil-off gas-based load assigned to each of the engines” calculated in (b). (For example, natural gas:fuel oil=7:3)

(d) Each engine is operated such that fuel oil and boil-off gas in the storage tank are used as a fuel according to the ratio determined in (c).

(e) If the pressure of boil-off gas in the storage tank is changed during operation of each engine, the procedure from (a) to (d) is repeated based on the changed pressure.

When the power management system (PMS) is in the mixed mode of the fuel sharing mode (FSM) and the fuel oil mode (FO mode),

(a) the amount of boil-off gas expected to be used as a fuel is determined based on the measured pressure of boil-off gas in the storage tank, and the maximum load that can be obtained when operating the engines in the fuel sharing mode using a determined amount of boil-off gas (hereinafter, “maximum boil-off gas-based engine load”) is calculated;

(b) the “maximum boil-off gas-based engine load” calculated in (a) is divided by the “total number of engines in the fuel sharing mode” to calculate a “boil-off gas-based load assigned to each of the engines in the fuel sharing mode”;

(c) A ratio of natural gas to fuel oil for each of the engines in the fuel sharing mode is determined based on the “boil-off gas-based load assigned to each of the engines in the fuel sharing mode” calculated in (b) (for example, natural gas:fuel oil=7:3);

(d) engine output required for the ship, excluding the load assigned to the engines in the fuel sharing mode, is allowed to be generated by engines in the fuel oil mode;

(e) each engine is operated such that fuel oil and boil-off gas in the storage tank are used as a fuel according to the ratio of natural gas to fuel oil for each of the engines in the fuel sharing mode determined in (c) and the load met by the engines in the fuel oil mode determined in (d); and

(f) if the pressure of boil-off gas in the storage tank is changed during operation of each engine, the procedure from (a) to (e) is repeated based on the changed pressure.

When the power management system (PMS) is in the mixed mode of the fuel sharing mode (FSM) and the gas mode,

(a) the amount of boil-off gas expected to be used as a fuel is determined based on the measured pressure of boil-off gas in the storage tank, and the maximum load that can be obtained when operating the engines in the fuel sharing mode and the engines in the gas mode using a determined amount of boil-off gas (hereinafter, “maximum boil-off gas-based engine load”) is calculated;

(b) the “maximum boil-off gas-based engine load” calculated in (a) is first distributed to the engines in the gas mode. Since gas is less expensive than fuel oil, it is preferable to preferentially distribute the load to the engines in the gas mode;

(c) the “maximum boil-off gas-based engine load”, excluding the load distributed to the engines in the gas mode in (b), is divided by the “number of engines in the fuel sharing mode” to calculate a “boil-off gas-based load assigned to each of the engines in the fuel sharing mode”;

(d) a ratio of natural gas to fuel oil for each of the engines in the fuel sharing mode is determined based on the “boil-off gas-based load assigned to each of the engines in the fuel sharing mode” calculated in (c) (for example, natural gas:fuel oil=7:3);

(e) each engine is operated such that fuel oil and boil-off gas in the storage tank are used as a fuel according to the load met by the engines in the gas mode, determined in (b), and the ratio of natural gas to fuel oil for each of the engines in the fuel sharing mode, determined in (d);

(f) if the pressure of boil-off gas in the storage tank is changed during operation of each engine, the procedure from (a) to (e) is repeated based on the changed pressure; and

(g) if the amount of boil-off gas in the storage tank is reduced, the proportion of fuel oil for the engines in the fuel sharing mode is increased to meet the engine output required for the ship. If fuel oil is required above a certain level, some or all of the engines in the gas mode are switched to the fuel sharing mode.

The DF engine operable in the fuel sharing mode (FSM) may also be operated manually by a user operating a ship. In the case that the DF engine operable in the fuel sharing mode (FSM) is operated manually, if boil-off gas in the storage tank is sufficient to drive the engine, a user personally determines a point at which optimum efficiency can be achieved within the range of amount of boil-off gas allowable by the power management system (PMS) and the gas management system (GMS). In addition, if boil-off gas in the storage tank is not sufficient to drive the engine, a user personally determines a point at which optimum efficiency can be achieved to the extent that an operation method of forcibly vaporizing liquefied natural gas in the storage tank is maintained.

In the case that the DF engine operable in the fuel sharing mode (FSM) is manually operated by a user, the above embodiment can help to suggest a point where optimum efficiency can be achieved.

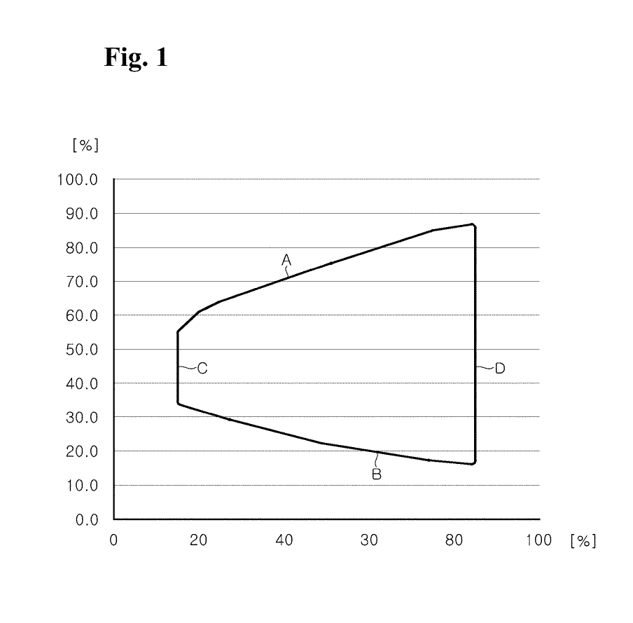

FIG. 1 is a graph showing the proportion of a gas-based load among a load of an engine in the fuel sharing mode (FSM) as a function of the load of the engine. In FIG. 1, the horizontal axis represents the “load of the engine” in % and the vertical axis represents the “proportion of a gas-based load” among the load of the engine in the fuel sharing mode (FSM) in %. In addition, A of FIG. 1 is a graph showing the “maximum value of the proportion of a gas-based load” as a function of the load of the engine; B of FIG. 1 is a graph showing the “minimum value of the proportion of a gas-based load” as a function of the load of the engine; C of FIG. 1 is a graph showing the minimum load of the engine; and D of FIG. 1 is a graph showing the maximum load of the engine.

Referring to FIG. 1, it can be seen that if the engine load is too high (approximately 85% or more) or too low (approximately 15% or less), the engine cannot be operated in the fuel sharing mode (FSM). Since, if the engine load is too high or too low, it is difficult to balance combustion explosion pressures of cylinders when injecting gas into the engine, the range of engine load within which that the engine can be operated in the fuel sharing mode (FSM) is limited.

In addition, it can be seen that the “proportion of a gas-based load” among the load of the engine is limited to about 15% or more and 85% or less. That is, the “proportion of a gas-based load” is limited in accordance with the engine load. For example, the engine in the fuel sharing mode (FSM) cannot be operated when the proportion of a gas-based load is 5%.

As shown in FIG. 1, as the engine load increases, the “maximum value of the proportion of a gas-based load” gradually increases and the “minimum value of the proportion of a gas-based load” gradually decreases. This indicates that, as the engine load increases, the acceptable range of the proportion of a gas-based load is widened.

The fuel sharing mode (FSM) has an advantage of minimizing discarded boil-off gas. However, since two different fuels, that is, gas and fuel oil, are burned together in the fuel sharing mode, careful adjustment of an air fuel ratio is necessary. If the air-fuel ratio is not properly controlled, the gas is not completely combusted and the unburned gas can be contained in exhaust gas and then discharged. In addition, when the gas is not combusted more often, stress received by internal components of the engine becomes larger. That is, when using the fuel sharing mode (FSM), the risk of damaging the engine is greater than when the engine is driven by the fuel oil alone.

When the engine is driven by the gas alone, emission of nitrogen oxides is low and the emission regulations of the IMO can be satisfied, whereas, when the fuel oil is injected into the engine in the fuel sharing mode (FSM), emission of nitrogen oxides sharply increases and it becomes difficult to satisfy the emission regulations of the IMO. Further, when the engine is driven the fuel sharing mode (FSM) using the fuel oil, which is a liquid fuel, a larger amount of sulfur oxides is emitted than when the engine is driven by gas alone.

Therefore, when the power management system (PMS) is in the mixed mode of the fuel sharing mode (FSM) and the gas mode, it is possible to prevent damage to the engine and to reduce the emission of nitrogen oxides and sulfur oxides by maximizing the number of engines in the gas mode and minimizing the number of engines in the fuel sharing mode (FSM).

In addition, when a load of each of the plurality of engines of a ship is maximized to minimize the number of engines to be driven, the number of idle engines is increased, thereby extending service life of the engines.

One embodiment of a method of maximizing the number of engines in the gas mode to minimize the number of engines in the fuel sharing mode (FSM) and maximizing a load of each individual engine when the power management system (PMS) is in the mixed mode of the fuel sharing mode (FSM) and the gas mode is as follows.

(a) The “total gas-based engine load” is calculated based on the pressure of boil-off gas in the storage tank. The “total gas-based engine load” includes the gas-based load of engines in the fuel sharing mode as well as the total load of engines in the gas mode.

(b) The “total fuel oil-based engine load” is calculated by subtracting the “total gas-based engine load” calculated in (a) from engine output required for the ship. If the engine output power required for the ship is smaller than the “total fuel oil-based engine load” calculated in (a), it is desirable that the power management system (PMS) be operated in the gas only mode rather than being operated in the mixed mode of the fuel sharing mode (FSM) and the gas mode and surplus boil-off gas be sent to the gas combustion unit (GCU) for combustion or vented to the outside.

(c) It is determined how many of the plurality of engines of the ship will be driven by taking into account the engine output required for the ship and the maximum output of each engine. Here, each engine is operated at the maximum load to minimize the number of engines to be operated (hereinafter, “the number of running engines”).

(d) A “gas-based engine load” assigned to each engine is determined by dividing the “total gas-based engine load” calculated in (a) by the “number of running engines” calculated in (c). Although it is desirable that the respective “gas-based engine loads” assigned to engines in the gas mode and engines in the fuel sharing mode be the same, the “gas-based engine loads” of all the engines are not necessarily the same. However, preferably, the respective loads of engines in the gas mode are the same and the respective loads of engines in the fuel sharing mode are the same. (For example, fuel sharing mode:gas mode:gas mode=5000:5500:5500)

(e) The number of engines that will share the “total fuel oil-based engine load” calculated in (b) is determined by taking into account the maximum load of each engine. Since the power management system (PMS) according to the present invention is in the mixed mode of the fuel sharing mode (FSM) and the gas mode, only the engines in the fuel sharing mode (FSM) are fueled by fuel oil. Thus, engines sharing the “total fuel oil-based engine load” are engines in the fuel sharing mode.

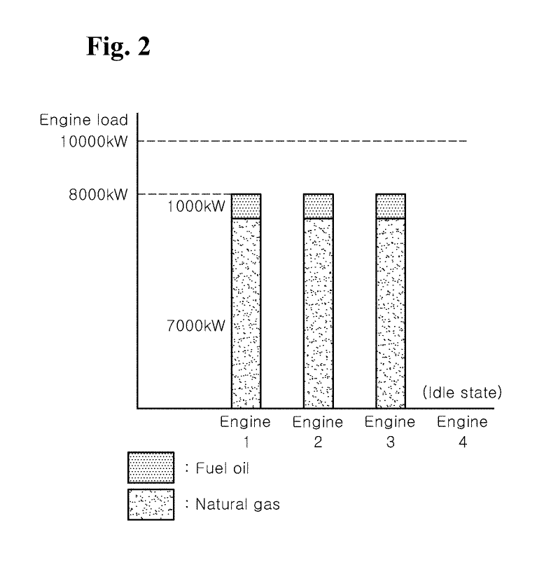

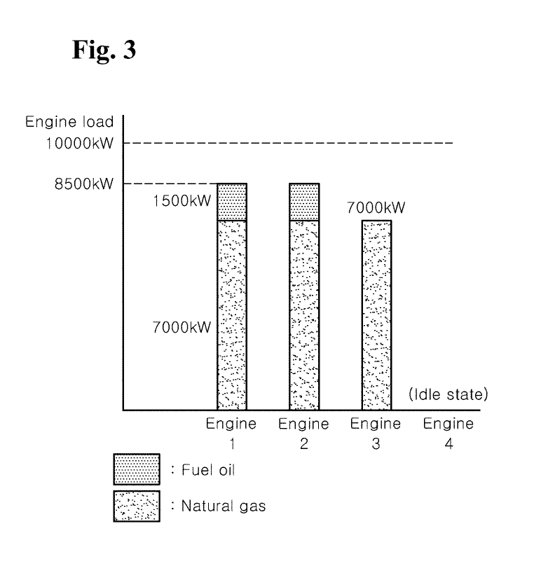

FIG. 2 is a graph showing a typical engine operating method for a ship when the total engine output required for the ship is 24,000 kW, and FIG. 3 is a graph showing an engine operating method for a ship according to one embodiment of the present invention when the total engine output power required for the ship is 24,000 kW. The engine operating method for a ship according to this embodiment will be described in comparison with the typical method with reference to FIGS. 2 and 3.

When four engines are provided to the ship, according to the typical engine operating method for a ship, three of the four engines are driven in the fuel sharing mode and the other engine is in an idle state. Accordingly, for each of the engines, the proportional expression of fuel oil-based engine load:natural gas-based engine load=1,000 kW:7,000 kW is satisfied.

Conversely, in the engine operating method for a ship according to this embodiment, when four engines are provided to the ship, one of the three running engines is driven in the gas mode to meet a load of 7,000 kW and the other two engines are driven in the fuel sharing mode. Accordingly, for each of the engines in the fuel sharing mode, the proportional expression of fuel oil-based engine load:natural gas-based engine load=1,500 kW:7,000 kW is satisfied.

In other words, in the engine operating method for a ship according to this embodiment, the number of engines in the fuel sharing mode is reduced from three to two, as compared with the typical engine operating method.

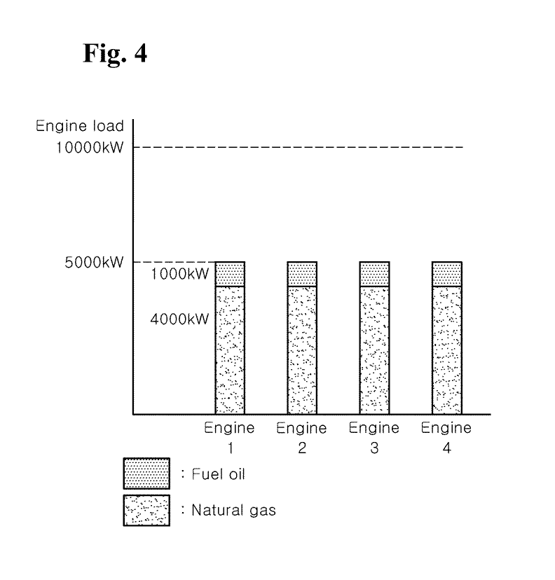

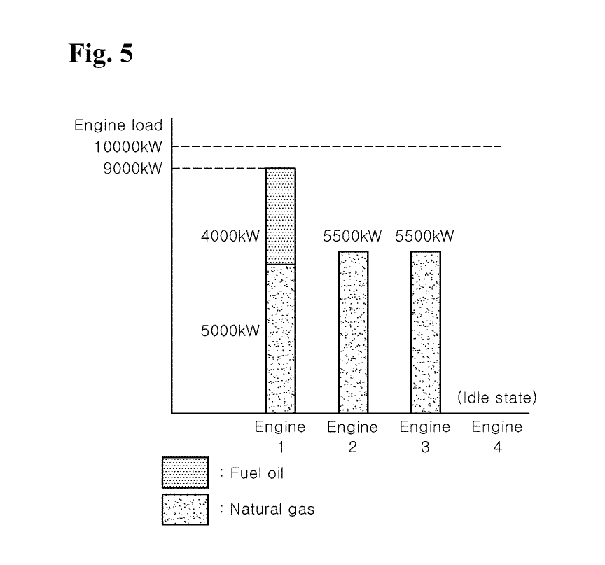

FIG. 4 is a graph showing a typical engine operating method for a ship when the total engine output required for the ship is 20,000 kW, and FIG. 5 is a graph showing an engine operating method for a ship according to one embodiment of the present invention when the total engine output required for the ship is 20,000 kW. The engine operating method for a ship according to this embodiment will be described in comparison with the typical method with reference to FIGS. 4 and 5.

When four engines are provided to the ship, according to the typical engine operating method for a ship, all four engines are driven in the fuel sharing mode. Accordingly, for each engine, the proportional expression of fuel oil-based engine load:natural gas-based engine load=1,000 kW:4,000 kW is satisfied.

In contrast, in the engine operating method for a ship according to this embodiment, when four engines are provided to the ship, only three engines are driven and two of the three running engines are driven in the gas mode to each output 5,500 kW while the other engine is driven in the fuel sharing mode. Accordingly, for the engine in the fuel sharing mode, the proportional expression of fuel oil-based engine load:natural gas-based engine load=4,000 kW:5,000 kW is satisfied.

Next, when the total engine output required for the ship is 20,000 kW, an engine operating method for a ship according to one embodiment of the present invention will be described with reference to the “embodiment of the method for maximizing the load of each individual engine” and FIG. 5.

When 20,000 kW of the total engine output required for the ship is divided by 9,000 kW, which is determined as the maximum output of each engine, as in (c) of the embodiment of the method for maximizing the load of each individual engine, it can be seen that three engines can meet the total engine output required for the ship (∵9000 kW×3>20,000 kW). Accordingly, unlike the typical engine operating method in which the four engines are all used, the engine operating method for a ship according to this embodiment allows only three engines to be used. In accordance with the engine operating method for a ship according to this embodiment, the load of each individual engine is maximized to minimize the number of engines to be operated, thereby extending the service life of the engines.

In addition, when the “total gas-based engine load”, 16,000 kW is divided by the “number of running engines”, 3, as in (d) of the embodiment of the method for maximizing the load of each individual engine, it can be seen that it is appropriate for each engine to meet a load of about 5,000 kW to about 5,500 kW. Thus, the load of each of the engines in the gas mode is determined to be 5,500 kW such that the respective loads of the engines in the gas mode can be the same.

Since the maximum load of each engine is 9,000 kW, when the remaining “gas-based engine load” is assigned to the remaining one engine in the fuel sharing mode, the proportional expression of fuel oil-based engine load:natural gas-based engine load=4,000 kW:5,000 kW is satisfied, causing no problem. In accordance with the engine operating method for a ship according to this embodiment, the number of engines operated in the gas mode is maximized and the number of engines operated in the fuel sharing mode is minimized, such that it is possible to minimize instability in the fuel sharing mode and to minimize emission of nitrogen oxides and sulfur oxides generated during engine combustion.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

1. An engine operating method for a ship provided with engines operable using natural gas and fuel oil at the same time, wherein each of the engines is operated in any one of a gas mode in which each of the engines is driven using natural gas as a fuel, a fuel oil mode in which each of the engines is driven using fuel oil as a fuel, and a fuel sharing mode in which each of the engines is driven using natural gas and fuel oil at the same time.

2. The engine operating method according to claim 1, wherein each of the engines is operated in the fuel sharing mode through a process comprising: switching the engine to the fuel sharing mode; determining proportion of gas burned in the fuel sharing mode; calculating amount of gas consumed in the fuel sharing mode; and providing feedback on the state of the engine in the fuel sharing mode.

3. The engine operating method according to claim 1, wherein the engine operating method is determined by a power management system and a gas management system of an integrated automation system operated in conjunction with each other, the power management system being operated in any one of a diesel mode in which a plurality of engines of the ship are all in the fuel oil mode, a first mixed mode in which some of the plurality of engines are in the fuel oil mode and some of other engines are in the gas mode, a gas only mode in which the plurality of engines are all in the gas mode, a fuel sharing only mode in which the plurality of engines are all in the fuel sharing mode, a second mixed mode in which some of the plurality of engines are in the fuel sharing mode and some of other engines are in the gas mode, and a third mixed mode in which some of the plurality of engines are in the fuel sharing mode and some of other engines are in the fuel oil mode.

4. The engine operating method according to claim 3, wherein the gas management system measures an internal pressure of a liquefied natural gas storage tank provided to the ship and calculates a total load assignable to engines in the gas mode or proportion of a gas-based load among the total load assignable to engines in the fuel sharing mode based on the measured internal pressure of the storage tank.

5. The engine operating method according to claim 4, wherein the gas management system forcibly switches the engines operating in the gas mode to the fuel oil mode or the fuel sharing mode if the internal pressure of the storage tank decreases, and sends surplus boil-off gas to a gas combustion unit for combustion or vents surplus boil-off gas if the internal pressure of the storage tank increases.

6. The engine operating method according to claim 3, wherein the integrated automation system automatically assigns a load to each engine based on information on the total loads assignable to engines in the gas mode and engines in the fuel sharing mode calculated by the gas management system based on the internal pressure of the storage tank.

7. The engine operating method according to claim 4, wherein the power management system is operated in the fuel sharing only mode, and the gas management system (a) determines an amount of boil-off gas expected to be used as a fuel based on the measured pressure of boil-off gas in the storage tank and calculates the maximum load obtainable when operating the engines in the fuel sharing mode using a determined amount of boil-off gas (hereinafter, “maximum boil-off gas-based engine load”); (b) calculates a “boil-off gas-based load assigned to each engine” by dividing the “maximum boil-off-based engine load”, calculated in (a), by the “total number of engines”; (c) determines a ratio of natural gas to fuel oil for each engine based on the “boil-off gas-based load assigned to each engine” calculated in (b); (d) operates each engine such that fuel oil and boil-off gas in the storage tank are used as a fuel according to the ratio determined in (c); and (e) repeats the procedure from (a) to (d) based on a changed pressure if the pressure of boil-off gas in the storage tank is changed during operation of each engine.

8. The engine operating method according to claim 4, wherein the power management system is operated in the second mixed mode, and the gas management system (a) determines an amount of boil-off gas expected to be used as a fuel based on the measured pressure of boil-off gas in the storage tank and calculates the maximum load obtainable when operating the engines in the fuel sharing mode and the engines in the gas mode using a determined amount of boil-off gas (hereinafter, “maximum boil-off gas-based engine load”); (b) distributes the “maximum boil-off gas-based engine load” calculated in (a) to the engines in the gas mode; (c) calculates a “boil-off gas-based load assigned to each of the engines in the fuel sharing mode” by dividing the “maximum boil-off gas-based engine load” excluding the load distributed to the engines in the gas mode in (b) by the “number of engines in the fuel sharing mode”; (d) determines a ratio of natural gas to fuel oil for each of the engines in the fuel sharing mode based on the “boil-off gas-based load assigned to each of the engines in the fuel sharing mode” calculated in (c); (e) operates each engine such that fuel oil and boil-off gas in the storage tank are used as a fuel according to the load met by the engines in the gas mode, determined in (b), and the ratio of natural gas to fuel oil for each of the engines in the fuel sharing mode, determined in (d); (f) repeats the procedure from (a) to (e) based on a changed pressure if the pressure of boil-off gas in the storage tank is changed during operation of each engine; (g) increases proportion of fuel oil for the engines in the fuel sharing mode if the amount of boil-off gas in the storage tank is reduced, and switches some or all of the engines in the gas mode to the fuel sharing mode if fuel oil is required above a certain level.

9. The engine operating method according to claim 4, wherein the power management system is operated in the third mixed mode and the gas management system (a) determines an amount of boil-off gas expected to be used as a fuel based on the measured pressure of boil-off gas in the storage tank and calculates the maximum load obtainable when operating the engines in the fuel sharing mode using a determined amount of boil-off gas (hereinafter, “maximum boil-off gas-based engine load”); (b) calculates a “boil-off gas-based load assigned to each of the engines in the fuel sharing mode” by dividing the “maximum boil-off gas-based engine load”, calculated in (a), by the “total number of engines in the fuel sharing mode”; (c) determines a ratio of natural gas to fuel oil for each of the engines in the fuel sharing mode based on the “boil-off gas-based load assigned to each of the engines in the fuel sharing mode” calculated in (b); (d) assigns engine output required for the ship, excluding the load assigned to the engines in the fuel sharing mode, to engines in the fuel oil mode; (e) operates each engine such that fuel oil and boil-off gas in the storage tank are used as a fuel according to the ratio of natural gas to fuel oil for each of the engines in the fuel sharing mode, determined in (c) and the load assigned to the engines in the fuel oil mode, determined in (d); and (f) repeats the procedure from (a) to (e) based on a changed pressure if the pressure of boil-off gas in the storage tank is changed during operation of each engine.

10. The engine operating method according to claim 3, wherein each of the engines is operated manually by a user operating the ship, and
wherein, if boil-off gas in the storage tank is sufficient to drive the engine, the user personally determines a point at which optimum efficiency can be achieved within a range of amount of boil-off gas allowable by the power management system (PMS) and the gas management system (GMS), and if boil-off gas in the storage tank is not sufficient to drive the engine, the user personally determines a point at which optimum efficiency can be achieved to the extent that an operation method of forcibly vaporizing liquefied natural gas in the storage tank is maintained.

11. The engine operating method according to claim 1, wherein each of the engines is operated in the fuel sharing mode and a load of the engine is determined to be 15% or more and 85% or less of a total load of the engine.

12. The engine operating method according to claim 1, wherein each of the engines is operated in the fuel sharing mode and proportion of a gas-based load among a load of the engine is determined to be 15% or more and 85% or less of the load of the engine.

13. The engine operating method according to claim 1, wherein each of the engines is operated in the fuel sharing mode, and, as a load of the engine increases, the maximum proportion of a gas-based load among the load of the engine increases and the minimum proportion of a gas-based load among the load of the engine decreases.

14. The engine operating method according to claim 4, wherein the power management system is operated in the second mixed mode, and the number of engines in the gas mode is maximized and the number of engines in the fuel sharing mode is minimized.

15. The engine operating method according to claim 1, wherein the ship comprises a plurality of engines and a load of each individual engine is maximized to minimize the number of engines to be driven.

16. The engine operating method according to claim 14, comprising:
(a) calculating a “total gas-based engine load” based on a pressure of boil-off gas in the storage tank;
(b) calculating a “total fuel oil-based engine load” by subtracting the “total gas-based engine load” calculated in (a) from engine output required for the ship;
(c) determining the number of engines of the ship to be driven by taking into account the engine output required for the ship and the maximum output of each engine (hereinafter, “the number of running engines”);
(d) determining a “gas-based engine load” assigned to each engine by dividing the “total gas-based engine load” calculated in (a) by the “number of running engines” calculated in (c); and
(e) determining the number of engines that will share the “total fuel oil-based engine load” calculated in (b) by taking into account the maximum load of each engine.

17. The engine operating method according to claim 16, wherein the respective “gas-based engine loads” of engines in the gas mode and engines in the fuel sharing mode are the same.

18. The engine operating method according to claim 16, wherein the respective loads of engines in the gas mode are the same and the respective loads of engines in the fuel sharing mode are the same.

19. The engine operating method according to claim 1, wherein each of the engines is a four-stroke DF engine for power generation.

20. A ship comprising a plurality of DF engines operable in a fuel sharing mode, wherein the plurality of DF engines are operated in a gas mode or the fuel sharing mode and the number of DF engines operated in the gas mode is maximized and a load of each of the plurality of DF engines is maximized.
